(19) United States
(12) Patent Application Publication
(10) Pub. No.: US 2011/0078284 A1
(43) Pub. Date: Mar. 31, 2011

(54) METHOD FOR RECONFIGURING A SET OF COMPONENTS OF AN ELECTRONIC CIRCUIT, CORRESPONDING RECONFIGURATION SYSTEM AND CORRESPONDING DATA TRANSMISSION METHOD

(75) Inventors: Pierre Bomel, Concarneau (FR); Jean-Philippe Diguet, Guidel (FR); Guy Daniel Gogniat, Merlevenez (FR)

(73) Assignee: UNIVERSITE DE BRETAGNE SUD, Lorient (FR)

(21) Appl. No.: 12/865,752

(22) PCT Filed: Jan. 29, 2009
(86) PCT No.: PCT/FR2009/050133

§ 371 Date: Dec. 7, 2010

(30) Foreign Application Priority Data
Feb. 1, 2008 (FR) 08 50641

(51) Int. Cl. G06F 15/16

(52) U.S. Cl. 709/219

(57) ABSTRACT

A method for reconfiguring a set (4) of components of an electronic circuit (2) provided with memory resources (6), the circuit (2) being connected to a network (8), is characterized in that it includes a step of downloading configuration data for the set (4) to the memory resources (6) of the electronic circuit (2) from a server (10) connected to the network (8).

The present invention relates to a method for reconfiguring a set of components of an electronic circuit provided with memory resources, the circuit being connected to a network.

It relates also to a corresponding reconfiguration system and to a corresponding data transmission method.

More especially, the invention relates to FPGA (Field Programmable Gate Array) circuits which are conventionally composed of blocks of logic components which are programmable or configurable before being used for a particular function.

FPGA circuits thus provide reconfigurable systems-on-chip enabling systems to be constructed on demand.

In this context, the reconfiguration of FPGA circuits assumes cardinal importance in a large number of industrial applications.

Conventionally, the reconfiguration of an FPGA for a given function is effected by downloading reconfiguration data for the circuit from an external memory. When the user wishes to use the FPGA circuit for another function, it is necessary to reconfigure the circuit by downloading new configuration data from another external memory. Thus, it is necessary to provide as many external memories as functions of the FPGA circuit.

Recently, a method for reconfiguring an FPGA circuit has been proposed which enables only an elemental set of the components of the FPGA circuit to be reconfigured. This method is referred to as Virtex partial dynamic reconfiguration. It has the advantage of not having to reconfigure an entire FPGA circuit for each function and thus permits the provision of FPGA circuits having a smaller silicon surface area.

However, this method requires more files of configuration data suitable for each function of an elemental set of the components of the FPGA circuit. Thus it is necessary to have additional memory resources available in order to store all of the blocks of partial reconfiguration data.

As a result, the savings made on the actual components of FPGA circuits are partly lost in the memory. There is therefore, as it were, a migration of the square millimetres of silicon of FPGA circuits towards the memory.

Consequently, the advantage created by the increased re-use of the same FPGA circuit is masked by the necessity to have available numerous memories for storing the reconfiguration data which have a low rate of re-use.

The object of the invention is to solve those problems.

More especially, the object of the invention is to provide an inexpensive high-performance solution for the partial reconfiguration of an FPGA circuit.

To that end, the invention relates to a method for reconfiguring a set of components of an electronic circuit provided with memory resources, the circuit being connected to a network, characterized in that it comprises a step of downloading configuration data for the set to the memory resources of the electronic circuit from a server connected to the network.

According to particular embodiments, the method comprises one or more of the following features, taken in isolation or in accordance with any technically possible combination:
the server is connected to a second server by way of a second network,
it comprises a step of transmission by the electronic circuit of a downloading request to the server, the request comprising the identity of the configuration data,
the electronic circuit is an FPGA circuit,
the network is a local area network,
the local area network is an Ethernet network,
the network is a Wi-Fi wireless local area network,
the network is a CAN network,
   the step of downloading configuration data is implemented in accordance with an adaptive protocol for the data link level, which protocol is capable of adapting to the memory resources of the electronic circuit,
   the step of downloading configuration data is associated with a step, implemented by the adaptive protocol, of regulating the flow of the downloaded configuration data,
   the step of downloading configuration data is associated with a step, implemented by the adaptive protocol, of detecting errors in the transmission of the data.

The invention relates also to a system for reconfiguring a set of components of an electronic circuit provided with memory resources, the circuit being connected to a network, characterized in that it comprises means for downloading configuration data for the set to the memory resources of the electronic circuit from a server connected to the network.

The invention additionally relates to a data transmission method for the data link level, characterized in that it uses a data link between a server and an electronic circuit provided with memory resources, the data link being capable of adapting to the memory resources of the electronic circuit.

According to particular embodiments, the protocol comprises one or more of the following features, taken in isolation or in accordance with any technically possible combination:
it implements a regulation of the data flow between the server and the electronic circuit,
it implements a detection of data transmission errors between the server and the electronic circuit.

Thus, the invention enables the disadvantages of the Virtex partial dynamic reconfiguration method to be overcome by not having to use external memories in order to store the configuration data of FPGA circuits.

The invention is based on access, through a local area network, to a remote server comprising the configuration data at the data link layer (layer 2 of the OSI model).

Since the server is connected to the same network as the FPGA circuit, it is not necessary to provide a routing mechanism for the network layer (layer 3 of the OSI model). The invention thus provides a simple and inexpensive solution for the reconfiguration of FPGA circuits.

Embodiments of the invention will now be described in a more detailed but non-limiting manner with reference to the appended drawings, in which:

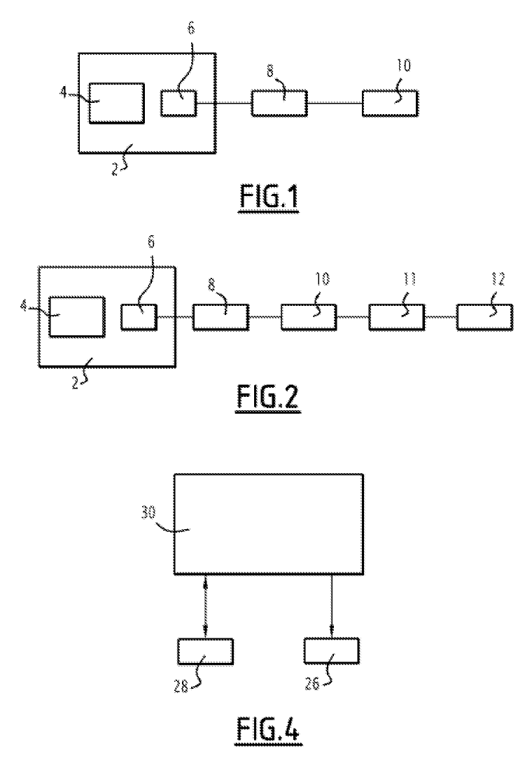

FIG. 1 is a block diagram illustrating the structure of a reconfiguration system according to a first embodiment of the invention;

FIG. 2 is a block diagram illustrating the structure of a reconfiguration system according to a second embodiment of the invention;

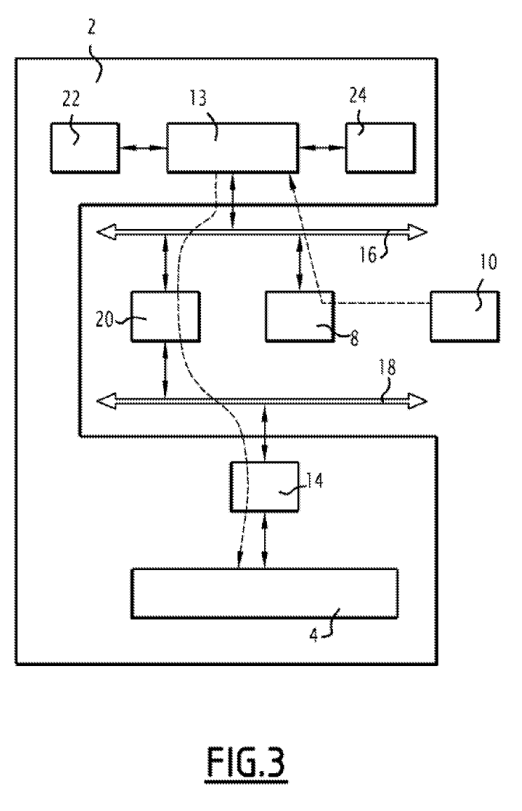

FIG. 3 is a block diagram illustrating the structure of the hardware means used in the reconfiguration system according to the invention;

FIG. 4 is a block diagram illustrating the structure of the software means used in the reconfiguration system according to the invention; and

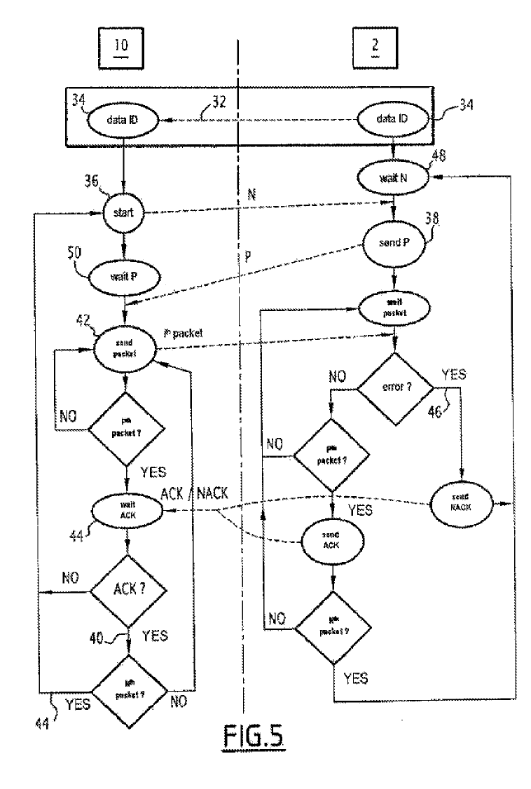

FIG. 5 is a flow chart illustrating the operation of the data transmission method according to the invention.

The system according to the invention permits the partial reconfiguration of an electronic circuit connected to a network by downloading configuration data for the relevant portion of the circuit from a server connected to the network.

The structure of such a system for the partial reconfiguration of an FPGA electronic circuit is illustrated in FIG. 1.

Such an FPGA electronic circuit is indicated by the general reference 2. In the embodiment shown in FIG. 1, the reconfiguration relates to a set 4 of components of the FPGA circuit 2.

Memory resources 6 are provided in the FPGA circuit 2 for storing digital data comprising bit streams.

In addition, the FPGA circuit 2 is connected to a local area network 8 to which is also connected a server 10 in which configuration data for different sets of components of the FPGA circuit 2 are stored.

In the following description, the local area network 8 is an Ethernet network.

In another embodiment, the local area network 8 is a Wi-Fi network. This is advantageous, in particular, for communication applications and roaming computing applications.

In another embodiment, the local area network 8 is a CAN network. This is advantageous, in particular, for electronic systems in motor vehicles.

According to a second embodiment of the invention shown in FIG. 2, the local server 10 is connected by way of a standard network, such as an IP network 11, to a second, global, server 12. This enables the local server 10 to refresh the configuration data from the global server 12. The global server 12 forms an integral part of the hierarchy of the configuration data servers. In normal operation, it enables the data of the local server 10 to be refreshed at a lower rate in accordance with the type of FPGA circuit 2 connected thereto by means of any type of standard data transfer protocol. Likewise, it enables the reconfiguration data to be transferred to the FPGA circuit 2 at a lower rate in the event of the absence or breakdown of the local server 10.

The detailed structure and operation of the reconfiguration system according to the invention are described in the following description with reference to FIGS. 3 to 5.

The system for reconfiguring the set 4 of components of the FPGA circuit 2 comprises means for downloading configuration data for the set 4 from the server 10 connected to the local area network 8. These downloading means comprise both hardware means and software means.

FIG. 3 is a block diagram illustrating the structure of the hardware means used in the reconfiguration system according to the invention.

In the example of hardware architecture of the system of the invention, the FPGA circuit 2 is provided with a data processing unit, for example, of the PowerPC type 13, for performing the downloading of configuration data, and with a configuration port 14 for controlling the contents of the set 4 of reconfigurable components.

The interface of the FPGA circuit 2 with the Ethernet network 8 is provided by means of two buses 16 and 18.

The bus 16 is called the PLB bus (Processor Local Bus) and is connected on the one hand to the PowerPC 13 of the FPGA circuit 2 and on the other hand to the Ethernet network 8.

The bus 18 is called the OPB bus (On-chip Peripheral Bus) and is connected to the configuration port 14.

Furthermore, a bridge 20 connects the PLB bus 16 and the OPB bus 18.

The PowerPC 13 is also associated with two memories 22 and 24 for the storage of data and executable programmes.

The memory 22 is called programme memory or LOCM (Instruction On Chip Memory) and the memory 24 is called data memory or DOCM (Data On Chip Memory).

The dotted arrows in FIG. 3 represent the transmission of the configuration data in the form of bit streams from the server 10 by way of the Ethernet network 8 to the FPGA circuit 2 in order to reconfigure the set 4 of components.

Thus, the bit streams representing the configuration data for the set 4 are downloaded from the server 10 via the Ethernet network 8 by the PowerPC 13.

The received configuration data bit streams are then interpreted by a dedicated data transmission protocol, which will be described in detail with reference to FIG. 5, and transmitted to the configuration port 14 via the PLB bus 16 and the OPB bus 18.

FIG. 4 is a block diagram illustrating the structure of the software means used in the reconfiguration system according to the invention.

The software means used in the system according to the invention comprise a driver 26 of the configuration port 14, a driver 28 of the Ethernet network 8 and a processing of the data transmission protocol dedicated to reconfiguration, indicated by the reference 30.

The desired aim of the software architecture represented in FIG. 4 is to eliminate to the maximum extent the stacking of software layers, thus making it possible to work at the lowest level of the OSI model, that is to say, layer 2 (data link layer).

The nature of the data transmission protocol for the configuration according to the invention is a source of enhanced performance because this protocol permits as efficient as possible an exchange of data between the Ethernet network 8 and the configuration port 14.

The system according to the invention provides for an exchange of the producer-consumer type between the Ethernet network 8 and the configuration port 14 in order to uncouple the loading of the configuration port 14 from the communication via the Ethernet network 8.

Thus, the Ethernet driver 28 fills an intermediate circular buffer (not shown) with packets of configuration data. This receipt of packets is effected by bursts of a size at most equal to half the capacity of the buffer. The configuration protocol processing 30 is carried out at the same time and transfers the packets received from the buffer of the Ethernet network 8 into the configuration port 14 before initiating the reconfiguration of the set 4 of components of the FPGA circuit 2.

The dimensioning of the intermediate buffer is a critical point which permits the simultaneous operation of the receipt of the packets and the reconfiguration via the configuration port 14. The maximum number of packets in a burst depends on the memory resources 6 available, and the configuration protocol proposed by the invention supports memory configurations which are different and which are even variable over time in order to adapt the flow rate to the resources available at the instant of downloading. The objective is to allocate the buffer of the smallest possible size ensuring the highest possible flow rate.

FIG. 5 is a flow chart illustrating the operation of the data transmission protocol for the reconfiguration according to the invention.

In FIG. 5, the left-hand portion describes the behaviour of the server 10 and the right-hand portion describes the behaviour of the FPGA circuit 2.

The data transmission method according to the invention is located at layer 2 of the OSI model and uses a data link with error detection and flow control. The adaptability of this method corresponds to the ability it has to adapt to the memory resources 6 available on the FPGA circuit 2. In the event of a transmission error, the reconfiguration is stopped instantaneously after signalling the error to the transmitter. To do this, the Ethernet driver 28 detects any packet incorrectly transmitted and, owing to the fact that the packets are numbered in sequence from 1 to N, it is possible to detect any packet which is missing, duplicated or displaced in the flow.

According to one embodiment, a strategy of immediately interrupting bit stream communication is effected.

According to another embodiment, a strategy of immediately interrupting packet communication is effected.

A mechanism of flow regulation by the FPGA circuit is provided for. It consists in sending information to the server 10. Given that this retroaction suspends the transmission of data, it is necessary to send as few flow control packets to the server 10 as possible. According to one embodiment, a system of positive acknowledgement every P packets is provided for, P being determined by the protocol processing 30 in accordance with the memory resources 6 available at the instant of downloading.

The method can be used in two different modes. In “master” or “self-reconfiguration” mode, the FPGA circuit 2 decides on the moment of reconfiguration and transmits at 32 to the server 10 a downloading request comprising the identity of the reconfiguration data 34 (a bit stream file name in a tree structure by way of example). In “slave” mode, it receives the file directly without knowing the identity thereof.

At the start of transmission 36, the server 10 sends to the FPGA circuit 2 the total number of packets N which will be transmitted and the FPGA circuit 2 replies at 38 with the value of P.

At the start of transmission 36 and after each positive acknowledgement 40, the server 10 sends, at 42, P packets in bursts and then waits for the following acknowledgement at 44.

The transmission is thus composed of N/P bursts of P packets up to the N^{th} packet at 44 which ends the downloading session.

In the event of error detection at 46 or of hardware rebooting, the FPGA circuit 2 returns to its position of waiting 48 for the number N of the method.

In one embodiment, pausing means are provided to detect the sudden disappearance of one of the ends and to return the server 10 and/or the FPGA circuit 2 to their respective waiting positions 48 and 50.

Thus, in practice, the system according to the invention provides a solution for the partial reconfiguration of electronic circuits of the FPGA type which is ultra-light and inexpensive.

This solution comprises hardware and software means and also an implementation of a method for the transmission of specific data in order to obtain FPGA circuits which are reconfigurable via a standard network such as the Ethernet. These FPGA circuits are intended for on-board applications having very few hardware resources and benefiting from dedicated architectures.

The solution of the invention does not require external memories for storing the code of the executive of the configuration data nor a communication protocol buffer, given that the data transmission method of the invention is located at layer 2 of the OSI model.

Furthermore, the embodiment shown in FIG. 2 permits a hierarchical organisation of the reconfiguration data servers and the use of two distinct types of protocol. In this embodiment, this involves the use of one protocol at layer 2 of the OSI model on the local area network in order to communicate with the local server, and any type of standard protocol at the layers higher than or equal to 3 of the OSI model in order to gain access to the global server via a global network.

According to results obtained in experiments, the invention enables reconfiguration rates at least ten times faster than the best existing solutions to be attained.

1. Method for reconfiguring a set (4) of components of an electronic circuit (2) provided with internal memory resources (6), the circuit (2) being connected to a network (8), characterized in that it comprises a step of downloading (42) configuration data for the set (4) to the memory resources (6) of the electronic circuit (2) from a server (10) connected to the network (8).

2. Reconfiguration method according to claim 1, characterized in that the server (10) is connected to a second server (12) by way of a second network (11).

3. Reconfiguration method according to claim 1, characterized in that it comprises a step of transmission (32) by the electronic circuit (2) of a downloading request to the server (10), the request comprising the identity (34) of the configuration data.

4. Reconfiguration method according to claim 1, characterized in that the electronic circuit (2) is an FPGA circuit.

5. Reconfiguration method according to claim 1, characterized in that the network (8) is a local area network.

6. Reconfiguration method according to claim 5, characterized in that the local area network (8) is an Ethernet network.

7. Reconfiguration method according to claim 5, characterized in that the network (8) is a Wi-Fi wireless local area network.

8. Reconfiguration method according to claim 5, characterized in that the network (8) is a CAN network.

9. Reconfiguration method according to claim 1, characterized in that the step of downloading (42) configuration data is implemented in accordance with an adaptive protocol for the data link level, which protocol is capable of adapting to the memory resources (6) of the electronic circuit (2).

10. Reconfiguration method according to claim 9, characterized in that the step of downloading (42) configuration data is associated with a step, implemented by the adaptive protocol, of regulating the flow of the downloaded configuration data.

11. Reconfiguration method according to claim 9, characterized in that the step of downloading (42) configuration data is associated with a step, implemented by the adaptive protocol, of detecting errors in the transmission of the data.

12. System for reconfiguring a set (4) of components of an electronic circuit (2) provided with internal memory resources (6), the circuit (2) being connected to a network (8), characterized in that it comprises means for downloading configuration data for the set to the memory resources (6) of the electronic circuit (2) from a server (10) connected to the network (8).

13. Data transmission method for the data link level, characterized in that it uses a data link between a server (10) and an electronic circuit (2) provided with internal memory resources (6), the data link being capable of adapting to the memory resources (6) of the electronic circuit.

14. Transmission method according to claim 13, characterized in that it implements a regulation of the data flow between the server (10) and the electronic circuit (2).

15. Transmission method according to claim 13, characterized in that it implements a detection of data transmission errors between the server (10) and the electronic circuit (2).

16. Reconfiguration method according to claim 2, characterized in that it comprises a step of transmission (32) by the electronic circuit (2) of a downloading request to the server (10), the request comprising the identity (34) of the configuration data.

17. Reconfiguration method according to claim 2, characterized in that the electronic circuit (2) is an FPGA circuit.

18. Reconfiguration method according to claim 10, characterized in that the step of downloading (42) configuration data is associated with a step, implemented by the adaptive protocol, of detecting errors in the transmission of the data.

19. Transmission method according to claim 14, characterized in that it implements a detection of data transmission errors between the server (10) and the electronic circuit (2).
